(19) United States
(12) Patent Application Publication
(10) Pub. No.: US 2018/0101855 A1
(43) Pub. Date: Apr. 12, 2018

(54) AUTOMATED REWARD MECHANISM FOR GRAPHIC CONTENT SELECTION

(71) Applicant: INTERNATIONAL BUSINESS MACHINES CORPORATION, ARMONK, NY (US)

(72) Inventors: LISA SEACAT DELUCA, BALTIMORE, MD (US); JEREMY A. GREENBERGER, RALEIGH, NC (US); TRUDY L. HEWITT, CARY, NC (US)

(21) Appl. No.: 15/291,222

(22) Filed: Oct. 12, 2016

(51) Int. Cl. G06Q 30/02; G06F 3/0482; G06F 17/21; G06Q 50/00

(52) U.S. Cl. CPC G06Q 30/0214; G06F 3/0482; G06Q 50/01; G06Q 30/0257; G06F 17/218

(57) ABSTRACT

Aspects automatic provide compensation in response to graphic item selection. in response to a selection by a viewing user of a graphic item visible within an image published on an interactive web-based service, aspects analyze text content posted on the interactive web-based service in association with the published image to identify a reference by the viewing user to the graphic item within the analyzed text content. In response to determining that the selection of the item is associated with a reference by the viewing user to the graphic item within the analyzed text content, an item selection action defined for the graphic item is executed and a reward value is provided to another, different user that published the image on the interactive web-based service.

### BACKGROUND

Web-based interactive networking services allow users to read content as well as generate content via posting or sharing (and thereby publishing or otherwise spreading) a wide variety of text, visual and audio content with other users and readers. Interactive networking services comprehend a variety of public or private networked resources, including social networking services, an electronic commerce (“ecommerce”) web page storefront that offers items for sale and posts comments or reviews from viewers in association with offered items, web-based posting forums, bulletin boards, diaries and logs (“blogs”), news feeds, wiki sites, media web sites, shared storage devices and systems, interactive web pages, spreadsheets, web-based documents, etc.

Online social network services comprehend a variety of media, network and site infrastructures that connect users to other individuals and groups. Social networking services may encourage users to engage in extended dialogues through commentary applications associated with user item postings, such as a photograph or still image, video and audio media content, web link citations, etc. Such forums transform users from passive consumers of digital content to publishers of the content spread thereon, and a given posted item may be effectively published to a large number of other users, in proportion to amounts of sharing and commentary activity that the posting generates.

On-line publication activity may result in remuneration of rewards and other valuable consideration to content providers, in consideration for generating measured viewing activity by other users or viewers of an interactive web-based service. For example, advertisements may be added to or otherwise associated with a published posting, wherein the posting user is paid a fixed fee for each new view of the posting by another, unique person, sometimes referred to as a “page view.” Affiliate marketing is a type of performance-based marketing in which a business rewards one or more affiliates for each visitor or customer brought in, as determined by unique page views of said visitors or customers.

### BRIEF SUMMARY

In one aspect of the present invention, a computerized method for automatic content generator compensation in response to graphic item selection includes executing steps on a computer processor. Thus, a computer processor, in response to a selection by a viewing user of a graphic item that is visible within an image published on an interactive web-based service, analyzes text content posted on the interactive web-based service in association with the published image to identify a reference by the viewing user to the graphic item within the analyzed text content. In response to determining that the selection of the graphic item is associated with a reference by the viewing user to the graphic item within the analyzed text content, an item selection action defined for the graphic item is executed. In response to the execution of the item selection action defined for the graphic item, a reward value is provided to another user that published the image on the interactive web-based service, wherein the another user is different from the viewing user that selected the graphic item and posted the analyzed text content.

In another aspect, a system has a hardware processor in circuit communication with a computer readable memory and a computer-readable storage medium having program instructions stored thereon. The processor executes the program instructions stored on the computer-readable storage medium via the computer readable memory and thereby, in response to a selection by a viewing user of a graphic item that is visible within an image published on an interactive web-based service, analyzes text content posted on the interactive web-based service in association with the published image to identify a reference by the viewing user to the graphic item within the analyzed text content. In response to determining that the selection of the graphic item is associated with a reference by the viewing user to the graphic item within the analyzed text content, an item selection action defined for the graphic item is executed. In response to the execution of the item selection action defined for the graphic item, a reward value is provided to another user that published the image on the interactive web-based service, wherein the another user is different from the viewing user that selected the graphic item and posted the analyzed text content.

In another aspect, a computer program product for automatic content generator compensation in response to graphic item selection has a computer-readable storage medium with computer readable program code embodied therewith. The computer readable hardware medium is not a transitory signal per se. The computer readable program code includes instructions for execution which cause the processor to, in response to a selection by a viewing user of a graphic item that is visible within an image published on an interactive web-based service, analyzes text content posted on the interactive web-based service in association with the published image to identify a reference by the viewing user to the graphic item within the analyzed text content. In response to determining that the selection of the graphic item is associated with a reference by the viewing user to the graphic item within the analyzed text content, an item selection action defined for the graphic item is executed. In response to the execution of the item selection action defined for the graphic item, a reward value is provided to another user that published the image on the interactive web-based service, wherein the another user is different from the viewing user that selected the graphic item and posted the analyzed text content.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts a cloud computing node according to an embodiment of the present invention.

FIG. 3 depicts a computerized aspect according to an embodiment of the present invention.

FIG. 4 is a flow chart illustration of a process or system for automatic content generator compensation in response to graphic item selection according to an embodiment of the present invention.

FIG. 5 is a flow chart illustration of a process or system for automatic content generator compensation in response to graphic item selection according to another embodiment of the present invention.

FIG. 6 is a graphic illustration of an implementation of an aspect of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

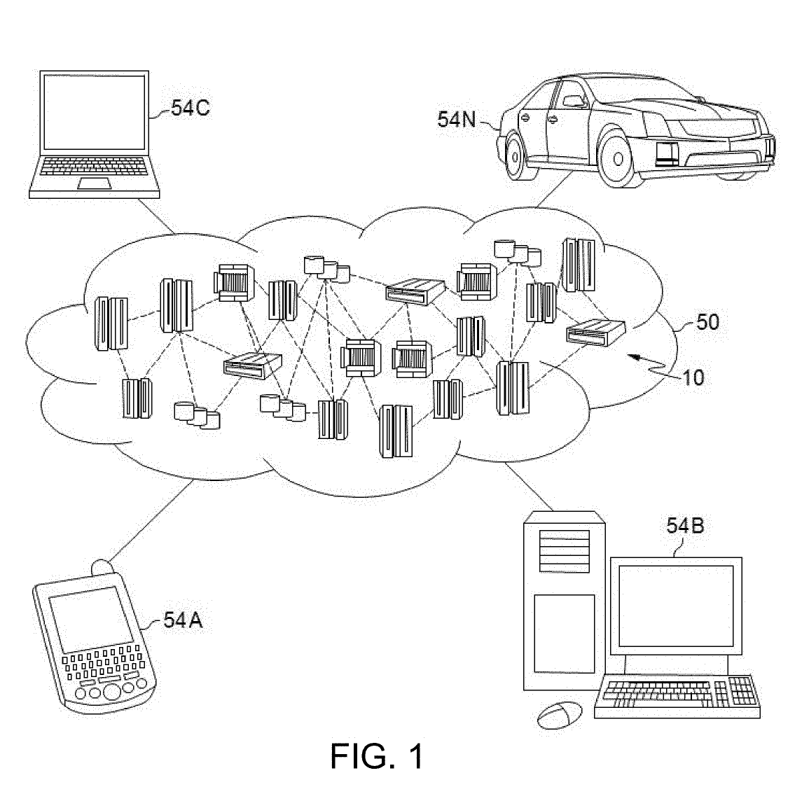

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

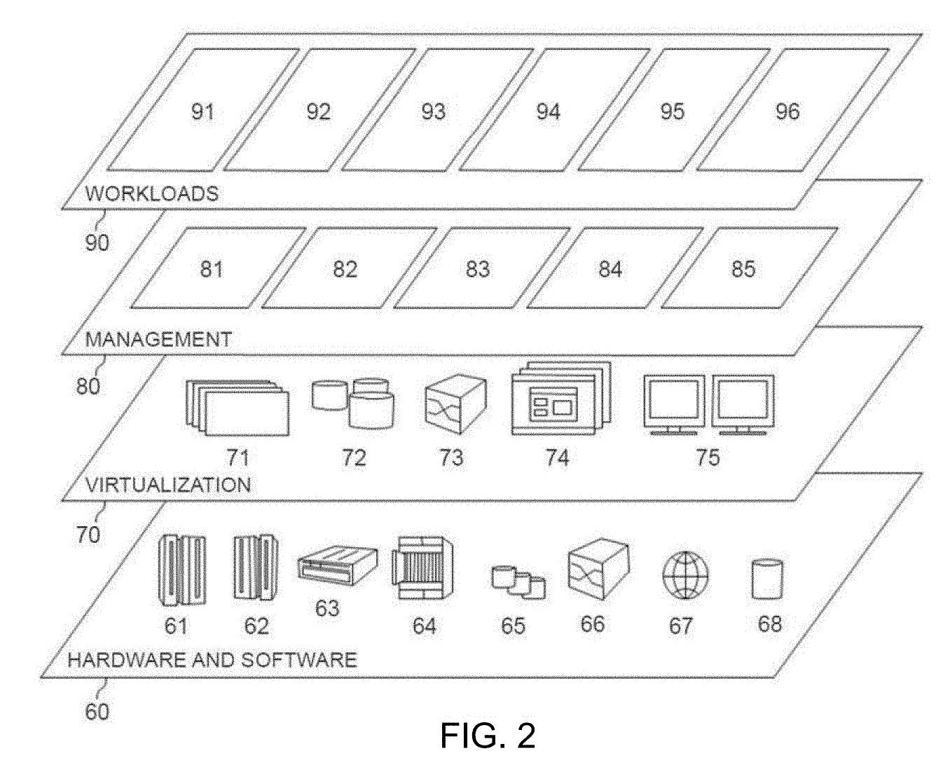

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

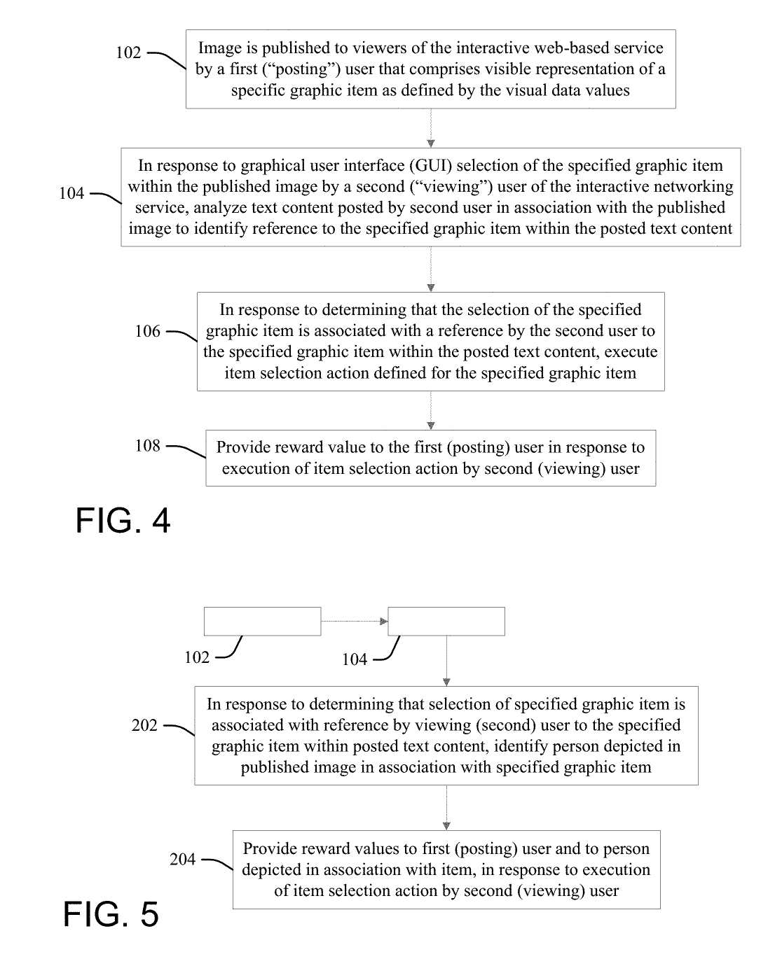

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 according to embodiments for automatic content generator compensation in response to graphic item selection as depicted in FIGS. 4-6 as described below.

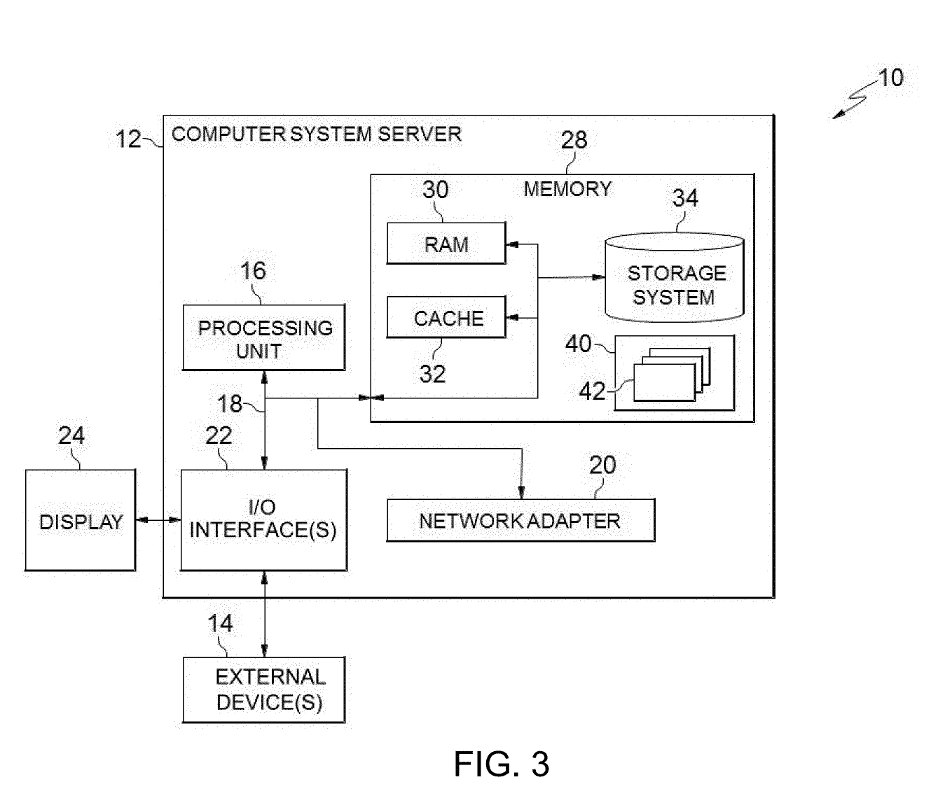

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

FIG. 4 illustrates a process or system according to the present invention for automatic content generator compensation in response to graphic item selection. At 102 an image (photograph, graphic illustration, video segment, etc.) is posted, uploaded or otherwise published to viewers of the interactive web-based service by a first (“posting”) user, wherein the image comprises a visible representation of a specific graphic item as defined by the unique set of visual data values. A visible representation of the specific graphic item is one wherein the scale of the specified item relative to the size or zoom of published image is sufficient in size, and the image data is sufficiently focused, that the item is distinctly legible by a viewer of the published image from other graphic elements within the image.

Examples of the visual data defining the specific graphic item include pixel data values, and optionally specific and distinctive color tone data values, that distinguish the item from other elements or image data visible within photographs, video segment image data and other graphic composition publications displayed (published) to users on a graphic display device of a smart phone, computer device, etc. Distinguishing elements includes distinguishing between different visual elements, such as between different people visible in a picture wherein visible people may be identified and distinguished from each other from differences in visual data used to depict each person, as well as distinguishing attributes of object elements (clothing items, sporting equipment, transportation items, etc.) from people and other objects, and from general contextual visual image data, such as surrounding pixel data defining image background or foreground elements that include sky, water, walls, forest, grass, floors, and other visual elements.

Sets of visual data defining the specified graphic item and other elements within an image publication may also be recognized or identified via metadata. For example, people or objects may be tagged as discrete visual elements with identification data by users viewing published graphic items, and visual data sets used to render the tagged item thereby defined for recognition of the item in other publications.

In the case of a social networking service, the image is generally published at 102 in response to upload or posting to an account application of the first user, wherein other users have access to the published image, and it is automatically shared with the other users, as a function of linking relationships of the other users to the first user as defined by the social networking service. Illustrative but not limiting or exhaustive examples of linking relationships defined within social networking services include friends, relatives, business colleagues, referral network members, school classmates, etc.

At 104, in response to a selection of the specified graphic item within the published image by a second (“viewing”) user of the interactive networking service via a graphical user interface (GUI) routine selection action, aspects analyze text content posted by a second, viewing user in association with the published image (a comment, a review, a blog entry, etc.) to identify any reference by the second user to the specified graphic item within the posted text content. Comments by the second user on the published image are generally posted and published in association with the image to other users of the interactive web-based service within a separate comment window, widget or application that is associated with a display of the published item.

Examples of selection of the specified graphic item at 104 include a manual selection by a viewing user through a “clicking” on the item as displayed via a mouse, cursor, touch screen or other GUI selection procedure, or via a voice selection command identified by natural language processing (“select the yellow shirt”), and still other selection routines will be apparent to one skilled in the art.

Identifying references by the second user to the specified graphic item within the posted text content generally involves text analysis that searches for a name of the specified graphic item (“Fred, “polo shirt”, etc.) or type or category or other identifying indicia (“Fred's clothing,” “her top”, “yellow garment”, etc.). Thus, a text analysis application executing on a processing unit cognitively and contextually analyzes metadata of the image and the text content of the comment to identify associations or relationships of terms and phrases within the comments to the specified graphic item.

At 106, in response to determining (recognizing, etc.) that the selection of the specified graphic item at 106 is associated with (occurs in the context of) a reference by the second user to the specified graphic item within the posted text content, an item selection action defined for the specified graphic item is executed. Illustrative but not limiting or exhaustive examples of actions defined for execution include incrementing a click counter that is used to determine rewards for price-per-click reward systems; redirecting a browser or other executing application of the second user from a current (“first”) website that is publishing the graphic data including the selectable graphic item to another (“second”) website, such as one with more information on the specified graphic item provided by a vendor, a wiki resource, etc.; to a social media account website for an entity associated with the specified graphic item (an advertiser, producer, retailer, wholesaler, etc.) in order to enable the second user of the item to “follow” the entity on the relevant social media service (to receive activity notifications or messages from the entity in a news feed application, etc.); to an e-commerce portal website that enables the second user to directly execute a purchase of a product represented by the specified graphic item; and still other redirections and defined actions will be apparent to one skilled in the art.

At 108 a reward value or other valuable consideration is provided to the first (posting) user in response to the execution of the item selection action at 106. For example, the reward may be defined as a price-per-click fee paid by an advertiser commercially promoting or marketing the specified graphic item, in some examples to both the social network provider publishing the graphic image (as is conventional in the prior art), and also to the first posting user, regardless and independent of any relationship to or agreement with the social network provider publishing the graphic image or to a content provider generating the image.

Thus, aspects of the present invention extend traditional price-per-click marketing agreements and revenue opportunities to the public at-large, wherein rewards for clicking on defined published content are not limited to only those entities under formal agreement with marketers providing the rewards. Aspects create a wiki-like advertising structure that greatly and rapidly scales-up conventional marketing efforts associated with the specified graphic item, through the help and participation of users of the social media network or other interactive web-based service.

Rewards may be conveyed automatically to the posting, first user at 108, without requiring prior or formal agreement by the first user to terms defining actions and responsibilities of the first user in order to receive the reward values. Thus, aspects provide additional advantages over prior art marketing agreements. As more interactive web-based service users of their own initiative and volition post, share or re-post image publications that include discernible representations of the specified graphic item, along with text content discussing or otherwise calling attention to the specified graphic item, marketing efforts proportionately expand, grow and mushroom in an organic, natural process that requires little or no effort by an advertising entity, merely the remuneration of price-per-click reward values to each of the posting users.

In some aspects, reward values at 108 may be differentiated, or limited or conditional upon meeting a threshold for determining a successful or complete execution of the action triggered at 106. For example, rewards granted to the posting first user may be conditional on verifying that the second user's browser completes a redirection to and engages the second website, via a click log or other history that indicates a field or radio button is subsequently selected on the second website confirming that the user actually viewed and read the second site to determine content therein; or that the second user added the specified graphic item to a shopping cart on the e-commerce portal, or completed a purchase of the specified graphic item once added to the shopping cart; or that the second user “likes” or “follows” the specified graphic item or other associated entity.

FIG. 5 illustrates another embodiment of the present invention that incorporates elements of the process of FIG. 4. Thus, subsequent to the step of analyzing text content posted by a second (“posting”) user in association with a published image to identify references to a specified graphic item within the posted text content (at 104, FIG. 4), at 202, in response to determining that the selection of the specified graphic item is associated with a reference by the second user to the specified graphic item within the posted text content, a person depicted in the image that is associated with the specified graphic item within the published image is identified (for example, via facial recognition processes, parsing metadata tags, etc.). Accordingly, at 204 reward values are provided to the first (posting) user and to the person depicted in association with the item, in response to execution of the item selection action by the viewing (second) user.

Association determination at 202 may distinguish between different people depicted in the published image, wherein only persons determined to be associated with the item receive rewards at 204, and no other, remaining people identifiable within the published image that are not associated with the item.

Determining association of a person with the specified graphic item at 202 may be dependent on an attribute (type, category, nature, etc.) of the item. Thus, if the specified graphic item is apparel, the association may be a determination that the depicted person is wearing the item, as distinguished from other persons visible within the image that are not wearing the item. If the specified graphic item is a sporting good item, the association may be a determination that the depicted person is physically engaging the item, for example, holding, kicking, hitting, throwing, operating, using, riding or otherwise interacting with the item. Thus, if the specified graphic item is a transportation item (bicycle, skateboard, automobile, jet ski, etc.), the association may a determination that the depicted person is riding on or operating the transportation item.

Aspects provide marketing advantages over prior art techniques, providing reward mechanisms that are not limited by prior agreement or relationship with content creators or publishers, encouraging the public at large to generate, post and comment on items within image publications that include the specified graphic item along with their own image and likeness, in consideration for realizing rewards from the comments and posting activities of friends, associates and other viewing users of the networking service publishing the image. Advertising campaigns may arise and spread organically, via the actions of the depicted persons and the posting users alone, without direction (or associated management efforts and costs) required or borne by an advertising entity. The only costs incurred may be for reward fees paid in response to successful marketing by the first users and the depicted persons, wherein the success of the efforts is evidenced by the selection and comment activities of the viewing users.

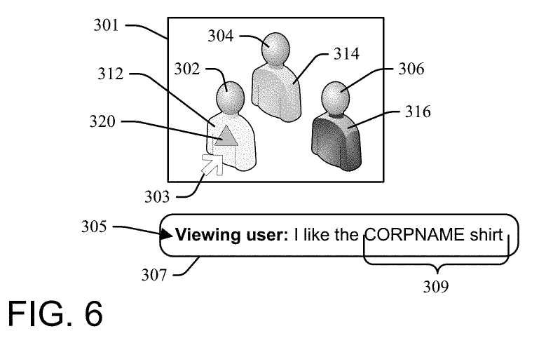

FIG. 6 illustrates an example wherein a photographic image 301 is published on a social network service by a first, posting user. The photograph 301 includes discernible images of three different people depicted therein (302, 304, and 306), and apparel items (shirts or tops) worn by each of them respectively (312, 314 and 316). Included within the discernible objects is a graphic item specifically defined as a function of visual data values (at 102 of FIG. 4 or FIG. 5): namely, the shirt 312 worn by a first of the depicted persons 302, which is defined by including a visual pixel data defining the logo 320 that is visible on the front of the shirt 312 in the photo 301.

Thus, in response to a GUI selection of the specified graphic item 312 within the published image 301 by the viewing user (via a click or other selection input while the cursor 303 is located upon the shirt 312, aspects of the present invention analyze text content 305 posted by the viewing user in association with the published image 301 (at 104 of FIG. 4 or FIG. 5). The text comment content 305 is published to social network service users having permission to view the photo 301 within a comment window 307.

Said analysis identifies (at 106 of FIG. 4, or 202 of FIG. 5) the phrase “CORPNAME shirt” 309 as a reference to the specified graphic item 312 that is visible within the photo 301, for example in response to metadata listing the entity name (“CORPNAME”) and a type or category of the specified graphic item 312 as “shirt” or “apparel” (where shirt and apparel are recognized as equivalent or related terms.)

Thus, in response to determining that the selection of the specified graphic item via the cursor 303 is associated with the reference 309 by the viewing user to the specified graphic item 312 within the posted text content 305, aspects of the present invention execute item selection action defined for the specified graphic item 312 and provide reward values to the first posting user who published (posted, liked, shared, etc.) the photo 301 on the social network service.

Aspects may also identify (at 202, FIG. 5) the depicted person 302 as associated with the specified graphic item 312, in response to determining: that the graphic item 312 is an item of apparel; that only depicted persons wearing items of apparel are considered associated with apparel items for purposes of providing rewards to persons depicted in association with the item in response to execution of item selection action by other viewing users (at 204, FIG. 5); and that person 302 is depicted within photo 301 as wearing the specified graphic item 312. In contrast, the other depicted persons 304 and 306 are determined to be not wearing the graphic item 312, but instead other shirts 314 and 316 (that are distinguished from the specified item 312 as a function of their omission of the logo 320), and therefore they are not provided with rewards in response to execution of item selection action by other viewing users (at 204, FIG. 5).

Identifying graphic image elements may be accomplished by a variety of techniques. Examples may apply facial recognition processes to the image data to identify the names of users or other persons depicted within the image data photos, or recognizing or decoding tagging or other metadata associated with the image data that identifies the person in photo data, wherein the associated comments are selected in response to including references to the identified names, or determining that said users uploaded published image data.

Attributes of a specified graphic item may also be considered in combination to distinguish and identify text comment data associated therewith, and general or generic comments regarding the specified graphic item thereby associated to the selected, specified graphic. For example, referring again to FIG. 6, text content that includes a generic descriptor term “shirt” that is applicable to the specified graphic item 312, considered with an identification indicia of the person 302 depicted as wearing the shirt 312 (for example, “Fred”), may identify (at 106 of FIG. 4, or 202 of FIG. 5) a text content reference to the selected, specified graphic item 312.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for automatic content generator compensation in response to graphic item selection, comprising executing on a computer processor the steps of:
in response to a selection by a viewing user of a graphic item that is visible within an image published on an interactive web-based service, analyzing text content of a comment posted within a comment application window by the viewing user on the interactive web-based service in association with the published image to identify a phrase within the posted comment that comprises a reference by the viewing user to an identifying indicia of the graphic item;
in response to determining that the selection of the graphic item is associated with a reference by the viewing user to the graphic item within the analyzed text content of the posted comment, executing an item selection action defined for the graphic item, and identifying a person depicted in the published image in an association with the graphic item that is selected from the group consisting of wearing the graphic item and physically engaging the graphic item; and
in response to the execution of the item selection action defined for the graphic item, providing a first reward value to the person depicted in the association with the graphic item and a second reward value to another user that published the image on the interactive web-based service, wherein the another user is different from the viewing user that selected the graphic item and posted the analyzed text content.

2. The method of claim 1, further comprising:
determining that the selection of the graphic item is associated with the reference by the viewing user to the identifying indicia of the graphic item in response to identifying within the analyzed text content indicia of the graphic item that is selected from the group consisting of a name of the graphic item, a type of the graphic item, a category of the graphic item and a color of the graphic item.

3. The method of claim 1, wherein the item selection action is selected from the group consisting of incrementing a click counter, redirecting a browser of the viewing user from a current website publishing the image to another website that comprises information associated with the graphic item, redirecting the browser of the viewing user from the current website to a social media account website for an entity associated with the graphic item, and redirecting the browser of the viewing user from the current website to an electronic commerce portal website that enables the viewing user to directly execute a purchase of a product represented by the graphic item.

4. The method of claim 3, wherein the step of providing the first reward value to the person depicted in the association with the graphic item and the second reward value to the user that published the image on the interactive web-based service is conditional on a determination selected from the group consisting of:
verifying that the viewing user selects a radio button on the another website that comprises the information associated with the graphic item;
verifying that the viewing user adds the graphic item to a shopping cart on the electronic commerce portal website; and
verifying that the viewing user completes a purchase of the graphic item on the electronic commerce portal website.

5. The method of claim 1, further comprising:
in response to determining that the selection of the graphic item is associated with the reference by the viewing user to the graphic item within the posted comment text content, identifying the person depicted in the published image in the association with the graphic item via distinguishing the identified person from another person visible in the published image as a function of determining that the another person visible in the published image is not depicted in the association with the item; and
in response to the execution of the item selection action defined for the graphic item, not providing a reward value to the another person that is determined to be visible in the published image and not depicted in the association with the graphic item.

6. (canceled)

7. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of analyzing the text content of the comment posted within the comment application window by the viewing user on the interactive web-based service in association with the published image to identify the phrase within the posted comment that comprises the reference by the viewing user to the identifying indicia of the graphic item within the analyzed text content of the posted comment in response to the selection by the viewing user of the graphic item that is visible within the image published on the interactive web-based service, executing the item selection action defined for the graphic item and identifying the person depicted in the published image in the association with the graphic item in response to determining that the selection of the graphic item is associated with the reference by the viewing user to the graphic item within the analyzed text content of the posted comment, and providing the first reward value to the person depicted in the association with the graphic item and the second reward value to the another user that published the image on the interactive web-based service in response to the execution of the item selection action defined for the graphic item.

8. The method of claim 7, wherein the computer-readable program code is provided as a service in a cloud environment.

9. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
in response to a selection by a viewing user of a graphic item that is visible within an image published on an interactive web-based service, analyzes text content of a comment posted within a comment application window by the viewing user on the interactive web-based service in association with the published image to identify a phrase within the posted comment that comprises a reference by the viewing user to an identifying indicia of the graphic item;
in response to determining that the selection of the graphic item is associated with a reference by the viewing user to the graphic item within the analyzed text content of the posted comment, executes an item selection action defined for the graphic item, and identifies a person depicted in the published image in association with the graphic item in response to determining an association selected from the group consisting of determining that the depicted person is wearing the graphic item and determining that the depicted person is physically engaging the graphic item; and
in response to the execution of the item selection action defined for the graphic item, provides a first reward value to the person depicted in the association with the graphic item and a second reward value to another user that published the image on the interactive web-based service, wherein the another user is different from the viewing user that selected the graphic item and posted the analyzed text content.

10. The system of claim 9, wherein the processor executes the program instructions stored on the computer-readable storage medium via the computer readable memory and thereby determines that the selection of the graphic item is associated with the reference by the viewing user to the identifying indicia of the graphic item in response to identifying within the analyzed text content indicia of the graphic item that is selected from the group consisting of a name of the graphic item, a type of the graphic item, a category of the graphic item and a color of the graphic item.

11. The system of claim 9, wherein the item selection action is selected from the group consisting of incrementing a click counter, redirecting a browser of the viewing user from a current website publishing the image to another website that comprises information associated with the graphic item, redirecting the browser of the viewing user from the current website to a social media account website for an entity associated with the graphic item, and redirecting the browser of the viewing user from the current website to an electronic commerce portal website that enables the viewing user to directly execute a purchase of a product represented by the graphic item.

12. The system of claim 11, wherein the processor executes the program instructions stored on the computer-readable storage medium via the computer readable memory and thereby conditions provision of the first reward value to the person depicted in the association with the graphic item and the second reward value to the user that published the image on the interactive web-based service on a determination that is selected from the group consisting of:
verifying that the viewing user selects a radio button on the another website that comprises the information associated with the graphic item;
verifying that the viewing user adds the graphic item to a shopping cart on the electronic commerce portal website; and
verifying that the viewing user completes a purchase of the graphic item on the electronic commerce portal website.

13. The system of claim 9, wherein the processor executes the program instructions stored on the computer-readable storage medium via the computer readable memory and thereby:
in response to determining that the selection of the graphic item is associated with the reference by the viewing user to the graphic item within the posted comment text content, identifies the person depicted in the published image in the association with the graphic item via distinguishing the identified person from another person visible in the published image as a function of determining that the another person visible in the published image is not depicted in the association with the item; and
in response to the execution of the item selection action defined for the graphic item, does not provide a reward value to the another person that is determined to be visible in the published image and not depicted in the association with the graphic item.

14. (canceled)

15. A computer program product for automatic content generator compensation in response to graphic item selection, the computer program product comprising:
a computer readable storage medium having computer readable program code embodied therewith, wherein the computer readable storage medium is not a transitory signal per se, the computer readable program code comprising instructions for execution by a processor that cause the processor to:
in response to a selection by a viewing user of a graphic item that is visible within an image published on an interactive web-based service, analyze text content of a comment posted within a comment application window by the viewing user on the interactive web-based service in association with the published image to identify a phrase within the posted comment that comprises a reference by the viewing user to an identifying indicia of the graphic item;
in response to determining that the selection of the graphic item is associated with a reference by the viewing user to the graphic item within the analyzed text content of the posted comment, execute an item selection action defined for the graphic item, and identify a person depicted in the published image in association with the graphic item in response to determining an association selected from the group consisting of determining that the depicted person is wearing the graphic item and determining that the depicted person is physically engaging the graphic item; and
in response to the execution of the item selection action defined for the graphic item, provide a first reward value to the person depicted in the association with the graphic item and a second reward value to another user that published the image on the interactive web-based service, wherein the another user is different from the viewing user that selected the graphic item and posted the analyzed text content.

16. The computer program product of claim 15, wherein the computer readable program code instructions for execution by the processor further cause the processor to determine that the selection of the graphic item is associated with the reference by the viewing user to the identifying indicia of the graphic item in response to identifying within the analyzed text content indicia of the graphic item that is selected from the group consisting of a name of the graphic item, a type of the graphic item, a category of the graphic item and a color of the graphic item.

17. The computer program product of claim 15, wherein the item selection action is selected from the group consisting of incrementing a click counter, redirecting a browser of the viewing user from a current website publishing the image to another website that comprises information associated with the graphic item, redirecting the browser of the viewing user from the current website to a social media account website for an entity associated with the graphic item, and redirecting the browser of the viewing user from the current website to an electronic commerce portal website that enables the viewing user to directly execute a purchase of a product represented by the graphic item.

18. The computer program product of claim 17, wherein the computer readable program code instructions for execution by the processor further cause the processor to condition provision of the first reward value to the person depicted in the association with the graphic item and the second reward value to the user that published the image on the interactive web-based service on a determination that is selected from the group consisting of:
verifying that the viewing user selects a radio button on the another website that comprises the information associated with the graphic item;
verifying that the viewing user adds the graphic item to a shopping cart on the electronic commerce portal website; and
verifying that the viewing user completes a purchase of the graphic item on the electronic commerce portal website.

19. The computer program product of claim 15, wherein the computer readable program code instructions for execution by the processor further cause the processor to:
in response to determining that the selection of the graphic item is associated with the reference by the viewing user to the graphic item within the posted comment text content, identify the person depicted in the published image in the association with the graphic item via distinguishing the identified person from another person visible in the published image as a function of determining that the another person visible in the published image is not depicted in the association with the item; and
in response to the execution of the item selection action defined for the graphic item, does not provide a reward value to the another person that is determined to be visible in the published image and not depicted in the association with the graphic item.

20. (canceled)
